(19) United States
(12) Patent Application Publication
(10) Pub. No.: US 2021/0363045 A1
(43) Pub. Date: Nov. 25, 2021

(54) PURE WATER PRODUCTION SYSTEM AND ULTRAVIOLET LIGHT IRRADIATION UNIT

(71) Applicant: DISCO CORPORATION, Tokyo (JP)

(72) Inventors: Jun SAITO, Tokyo (JP); Miki YOSHIDA, Tokyo (JP); Ken JOU, Tokyo (JP)

(21) Appl. No.: 17/242,900

(22) Filed: Apr. 28, 2021

(30) Foreign Application Priority Data
May 21, 2020 (JP) 2020-088910

(51) Int. Cl. C02F 9/00

(52) U.S. Cl. CPC C02F 9/00; C02F 1/001

(57) ABSTRACT

A pure water production system includes a filter unit, a clear water storage tank, an ultraviolet light irradiation unit, and an ion exchange resin unit. The filter unit filters water. The clear water storage tank stores water filtered by the filtration unit. The ultraviolet light irradiation unit irradiates ultraviolet light to water delivered from the clear water storage tank. The ion exchange resin unit produces pure water from water delivered from the ultraviolet light irradiation unit. The ultraviolet light irradiation unit includes an ultraviolet fluorescent lamp, and an outer tube configured to allow the water to flow through surroundings of the ultraviolet fluorescent lamp. The outer tube includes an inflow port through which the water flows in, and an outflow port through which the water irradiated with ultraviolet light from the ultraviolet fluorescent lamp flows out.

### BACKGROUND OF THE INVENTION

### Field of the Invention

The present invention relates to a pure water production system for producing pure water from waste fluid drained from a processing apparatus that processes wafers or the like formed of a semiconductor material, and also to an ultraviolet light irradiation unit that can be incorporated and used in the pure water production system.

### Description of the Related Art

In a fabrication process of device chips to be mounted on electronic equipment, a plurality of intersecting dicing lines (hereinafter called “streets”) is first set on a front surface of a wafer formed of a semiconductor material. Devices such as integrated circuits (ICs) or large scale integration (LSI) are then formed in individual regions defined by the streets, respectively. The wafer is subsequently divided along the streets, whereby a plurality of device chips are obtained. For the division of the wafer, a cutting apparatus that cuts the wafer by an annular cutting blade, or the like is used. Accompanying a trend toward smaller and thinner electronic equipment in recent years, there is also a growing demand for thinner device chips. Wafer thinning processing may hence be applied by grinding a wafer on a side of its back surface before its division. This wafer grinding processing uses a grinding apparatus that grinds the wafer by a grinding wheel with a plurality of grinding stones included therein, or the like.

When processing a wafer by a processing apparatus such as the above-described cutting apparatus or grinding apparatus, a processing fluid is supplied to the wafer. By the processing fluid, the wafer and a processing tool (a cutting blade, a grinding wheel, or the like) are cooled, and at the same time the resulting debris (processing debris) is rinsed off. If impurities are contained in the processing fluid, however, problems may arise including formation of marks due to the impurities deposited on the wafer and impurity-induced operation failures of devices, leading to a potential reduction in quality of device chips. As the processing fluid, pure water free of impurities is used accordingly. Pure water used in a processing apparatus is drained as waste fluid out of the processing apparatus and is then disposed of. However, the pure water used in the processing apparatus is voluminous, and non-negligible disposal cost is thus needed. Accordingly, methods have been proposed to purify waste fluid drained from a processing apparatus and to reuse it as water. For example, a pure water production system (processing fluid treatment system) is known (see Japanese Patent Laid-Open No. 2009-214193). According to this pure water production system, waste fluid is filtered to produce clear water, ultraviolet light is irradiated to the clear water to break down organic matter, and ion exchange resins are used to eliminate impurity ions from the clear water such that pure water is produced.

### SUMMARY OF THE INVENTION

Such a pure water production system includes, for example, a filter unit that filters water drained from a processing apparatus, an ultraviolet light irradiation unit that irradiates ultraviolet light to the water, an ion exchange resin unit that replaces ions contained in the water, and a microfilter portion that filters the water. The water filtered through the microfilter unit is adjusted to a predetermined temperature in a pure water supply unit and is then supplied to the processing apparatus.

Conventionally, the ultraviolet light irradiation unit includes a tank that stores water, and an ultraviolet light source that is disposed inside the tank to irradiate ultraviolet light to the water stored in the tank. For example, the ultraviolet light source is submerged in water stored in the tank. The ultraviolet light irradiation unit irradiates ultraviolet light to the water such that organic matter, such as microorganisms, contained in the water is broken down. The organic matter so broken down is eliminated from the water in the ion exchange resin unit. In the tank of the ultraviolet light irradiation unit, however, ultraviolet light cannot act at a sufficient intensity on water distant from the ultraviolet source, and therefore a portion of organic matter may remain in the water. The organic matter, which has not been broken down, cannot be eliminated in the ion exchange resin unit. Therefore, impurities may remain in the produced pure water.

The present invention therefore has as objects thereof the provision of a pure water production system and an ultraviolet light irradiation unit, which irradiate ultraviolet light to flowing water to enable sufficient breakdown of organic matter contained in the water.

In accordance with an aspect of the present invention, there is provided a pure water production system. The pure water production system includes a waste fluid storage tank that stores water drained from a processing apparatus, a filter unit that filters water delivered from the waste fluid storage tank, a clear water storage tank that stores water filtered by the filtration unit, an ultraviolet light irradiation unit that irradiates ultraviolet light to water delivered from the clear water storage tank and breaks down organic matter contained in the water, an ion exchange resin unit that replaces ions contained in water delivered from the ultraviolet light irradiation unit, thereby producing pure water from the water, and a pure water supply unit that supplies the pure water produced by the ion exchange resin unit to the processing apparatus. The ultraviolet light irradiation unit includes an ultraviolet fluorescent lamp, and an outer tube configured to allow the water to flow through surroundings of the ultraviolet fluorescent lamp, and the outer tube includes an inflow port through which the water flows in, and an outflow port through which the water irradiated with ultraviolet light from the ultraviolet fluorescent lamp flows out.

Preferably, the outer tube included in the ultraviolet light irradiation unit may be a helical tube of a shape that is wound in a helical pattern around the ultraviolet fluorescent lamp.

More preferably, a distance between an inner side of the helical tube and an outer side of the ultraviolet fluorescent lamp may be 7.5 mm or smaller.

Preferably, the outer tube included in the ultraviolet light irradiation unit may be a cylindrical tube disposed such that the ultraviolet fluorescent lamp is accommodated therein.

More preferably, a distance between an inner side of the cylindrical tube and an outer side of the ultraviolet fluorescent lamp may be 7.5 mm or smaller.

Preferably, the ultraviolet light from the ultraviolet fluorescent lamp may contain a 254-nm wavelength component and a 185-nm wavelength component. The ultraviolet fluorescent lamp may sterilize the water, which is flowing through the outer tube, by the 254-nm wavelength component of the ultraviolet light, and may degrade organic matter, which is contained in the water flowing through the outer tube, into ions by the 185-nm wavelength component of the ultraviolet light. The ultraviolet fluorescent lamp may be incorporated in the clear water storage tank, and may provisionally break down organic matter, which is contained in the water stored in the clear water storage tank, by a leak of the ultraviolet light through the outer tube.

According to a second aspect of the present invention, there is provided an ultraviolet light irradiation unit including an ultraviolet fluorescent lamp, and a helical tube of a shape that is wound in a helical pattern around the ultraviolet fluorescent lamp. The helical tube includes an inflow port through which water flows in, and an outflow port through which the water irradiated with ultraviolet light from the ultraviolet fluorescent lamp flows out.

In the first aspect of the present invention, the ultraviolet light irradiation unit includes the ultraviolet fluorescent lamp, and the outer tube configured to allow the water to flow through the surroundings of the ultraviolet fluorescent lamp. Further, the outer tube includes the inflow port through which the water flows in, and the outflow port through which the water irradiated with the ultraviolet light from the ultraviolet fluorescent lamp flows out. In the ultraviolet light irradiation unit, water flows inside the outer tube from the inflow port toward the outflow port, and in the course of the flow, ultraviolet light emitted from the ultraviolet fluorescent lamp is irradiated to the water. In this case, a region in which water can move is limited by the outer tube disposed surrounding the ultraviolet fluorescent lamp, thereby enabling to prevent the water to flow to a region so distant that the ultraviolet light is not irradiated sufficiently. In other words, the ultraviolet light can be sufficiently irradiated to the flowing water, and therefore can sufficiently break down organic matter contained in the water.

The present invention therefore provides the pure water production system and the ultraviolet light irradiation unit, which irradiate ultraviolet light to flowing water to enable sufficient breakdown of organic matter contained in the water.

The above and other objects, features and advantages of the present invention and the manner of realizing them will become more apparent, and the invention itself will best be understood from a study of the following description and appended claims with reference to the attached drawings depicting or illustrating a preferred embodiment of the invention.

### BRIEF DESCRIPTION OF THE DRAWINGS

FIG. 1 is a perspective view schematically depicting a processing apparatus and a pure water production system according to an embodiment of a first aspect of the present invention;

FIG. 2 is a perspective view schematically depicting an internal configuration of the pure water production system;

FIG. 3 is an exploded perspective view illustrating the internal configuration of the pure water production system and a connection layout of the internal configuration;

FIG. 4 is a cross-sectional view schematically depicting an ultraviolet light irradiation unit disposed in the pure water production system;

FIG. 5 is a side view schematically depicting a modification of the ultraviolet light irradiation unit;

FIG. 6 is an exploded perspective view illustrating an internal configuration of a pure water production system according to a first modification of the embodiment and a connection layout of the internal configuration; and

FIG. 7 is a cross-sectional view schematically depicting a clear water storage tank with the ultraviolet light irradiation unit of FIG. 5 incorporated therein, as disposed in a pure water production system according to a second modification of the embodiment.

### DETAILED DESCRIPTION OF THE PREFERRED EMBODIMENT

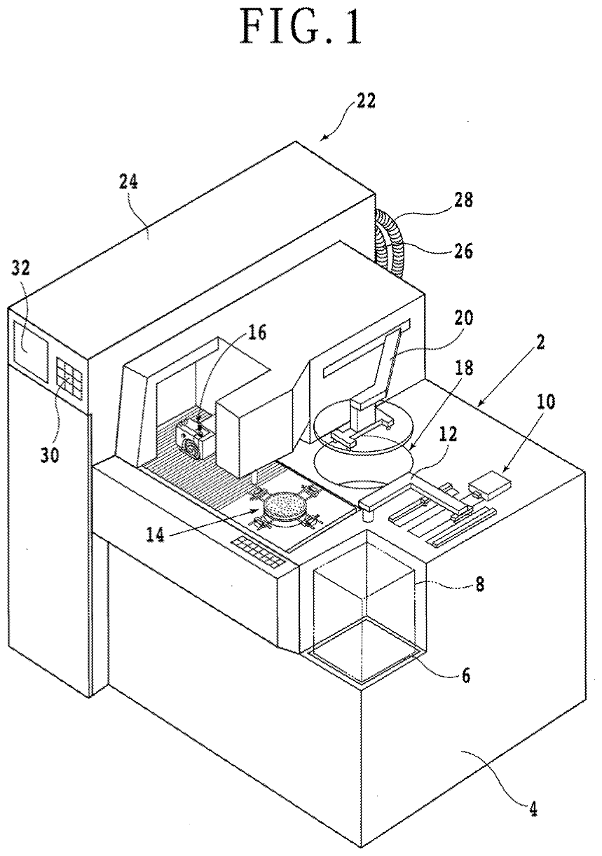

With reference to the attached drawings, an embodiment of the first aspect of the present invention will hereinafter be described. First, a description will be made about a configuration example of a pure water production system 22 according to this embodiment. FIG. 1 is a perspective view schematically depicting the pure water production system 22, and a processing apparatus 2 to which the pure water production system 22 is connected for use. On the processing apparatus 2, a workpiece such as a wafer formed of a semiconductor material such as, for example, silicon (Si) or silicon carbide (SiC) is processed. On a front surface of the wafer, a plurality of devices such as ICs or LSI is formed. If the wafer is divided device by device, individual device chips are formed. Further, if the wafer is thinned beforehand by grinding it on a side of a back surface thereof before its division, thin device chips are obtained eventually. The processing apparatus 2 performs processing such as grinding or dividing on the workpiece.

In FIG. 1, a cutting apparatus that includes an annular cutting blade mounted on a spindle is schematically depicted as an example of the processing apparatus 2. However, the processing apparatus 2 to which the pure water production system 22 according to this embodiment is connected for use is not limited to a cutting apparatus. For example, the processing apparatus 2 may be a grinding apparatus that rotates a grinding wheel, which has grinding stones secured in an annular pattern and is mounted on a spindle, and brings the grinding stones, which are moving on an annular track, into contact to perform grinding. A description will hereinafter be made taking as an example a case in which the processing apparatus 2 is the cutting apparatus. As depicted in FIG. 1, a cassette table 6 on which a cassette 8 is mounted is disposed in a corner part of a bed 4 of the processing apparatus 2. The cassette table 6 is movable up and down in an up-down direction by a lift mechanism (not depicted). In FIG. 1, the contour of the cassette 8 mounted on the cassette table 6 is indicated by two-dot chain lines.

At a position on an upper wall of the bed 4 and adjacent the cassette table 6, an unloading unit 10 is disposed to unload a workpiece, which is held in the cassette 8 mounted on the cassette table 6, from the cassette 8. The unloading unit 10 has on a front wall thereof a grasping portion that can grasp the workpiece. When desired to unload the workpiece held in the cassette 8, the grasping portion is inserted into the cassette 8 to grasp the workpiece by the grasping portion, and the grasping portion is then moved in a direction away from the cassette 8.

At the position on the upper wall of the bed 4 and adjacent the cassette table 6, a chuck table 14 that can hold the workpiece under suction is disposed. The chuck table 14 is movable in a direction away from and in a direction toward the cassette table 6. Further, a first transfer unit 12 is disposed adjacent the unloading unit 10 and the chuck table 14 on the upper wall of the bed 4. The first transfer unit 12 has a shaft portion that projects upward from the upper wall of the bed 4, is movable up and down and is rotatable, an arm portion that extends in a horizontal direction from an upper end of the shaft portion, and a holding portion that is disposed on a lower portion of a distal end of the arm portion. The workpiece pulled out of the cassette 8 is transferred onto the chuck table 14 by the first transfer unit 12.

At a destination of the chuck table 14, a processing unit (cutting unit) 16 is disposed to process (cut) the workpiece held on the chuck table 14. The processing unit 16 includes a cutting blade with an annular grinding stone portion secured on an outer periphery thereof, and a spindle carrying the cutting blade mounted on a distal end portion thereof, serving as an axis of rotation of the cutting blade and extending along a Y-axis direction. To the side of a proximal end of the spindle, a rotational drive source (not depicted) such as a motor is connected. When the cutting blade is rotated and the rotating cutting blade is brought into cutting engagement with the workpiece held on the chuck table 14, the workpiece can be cut. Thereafter, the chuck table 14 is returned to the position adjacent the cassette table 6.

At the position on the upper wall of the bed 4 and adjacent the chuck table 14 and the first transfer unit 12, a rinsing unit 18 is disposed to rinse the workpiece after the processing. The rinsing unit 18 includes a spinner table that holds the workpiece. To a lower portion of the spinner table, a rotational drive source (not depicted) is connected to rotate the spinner table at a predetermined speed. The processing apparatus 2 includes a second transfer unit 20 that transfers the workpiece from the chuck table 14 to the rinsing unit 18. When desired to rinse the workpiece by the rinsing unit 18, a rinsing fluid (typically, a mixed fluid of water and air) is ejected toward the workpiece while rotating the spinner table. When desired to hold the workpiece in the cassette 8 after its rinsing by the rinsing unit 18, the workpiece is transferred from the rinsing unit 18 to the unloading unit 10 by using the first transfer unit 12. The unloading unit 10 is then moved toward the cassette 8 to push the workpiece into the cassette 8.

It is to be noted that when a workpiece is cut by a cutting blade, frictional heat is generated and temperatures of the cutting blade and workpiece rise. In addition, processing debris is ejected from the workpiece. If a processing fluid is supplied to the cutting blade and the workpiece while cutting the workpiece, processing debris can be promptly removed and at the same time the cutting blade and the workpiece can be cooled. In a case that the processing apparatus 2 is a grinding apparatus which grinds a workpiece with grinding stones secured on a grinding wheel, on the other hand, frictional heat and processing debris are also generated when the workpiece is ground. If a processing fluid is supplied to the grinding stones and the workpiece while grinding the workpiece, processing debris can also be promptly removed and the grinding stones and the workpiece can also be cooled.

If impurities are contained in the processing fluid, however, problems may arise including the formation of marks due to the impurities deposited on the workpiece and impurity-induced operation failures of devices formed on the workpiece, leading to a potential reduction in the quality of device chips. As the processing fluid, pure water or the like which is free of impurities is used accordingly. Pure water used in the processing apparatus is drained as waste fluid out of the processing apparatus and is then disposed of. However, the pure water used in the processing apparatus is voluminous, and non-negligible disposal cost is thus needed. Therefore, the pure water production system 22 is used to reuse the waste fluid drained from the processing apparatus 2. The pure water production system 22 produces pure water, for example, by filtering the waste fluid to produce clear water, irradiating ultraviolet light to the clear water to break down organic matter, and eliminating impurities ions from the clear water with ion exchange resins. The pure water so produced is then supplied to the processing apparatus 2.

A description will next be made about the pure water production system 22. The pure water production system 22 is connected to the processing apparatus 2 that uses pure water. The pure water production system 22 has a pallalelepipedal housing 24, which accommodates individual elements that make up the pure water production system 22. On an upper part of a front wall of the housing 24, a display unit 32 and an input unit 30 are disposed. The display unit 32 is configured of a liquid crystal display or the like, and displays the status and the like of the pure water production system 22, and the input unit 30 is configured of a touch panel, buttons, or the like, and serves as an interface when an operator inputs commands to the pure water production system 22. The pure water production system 22 is connected to the processing apparatus 2 via a water drainage path 26 and a water supply path 28, which are formed of pipes, tubes, or the like. Pure water produced by the pure water production system 22 is delivered to the processing apparatus 2 through the water supply path 28, while water (waste fluid) generated in the processing apparatus 2 is delivered to the pure water production system 22 through the water drainage path 26.

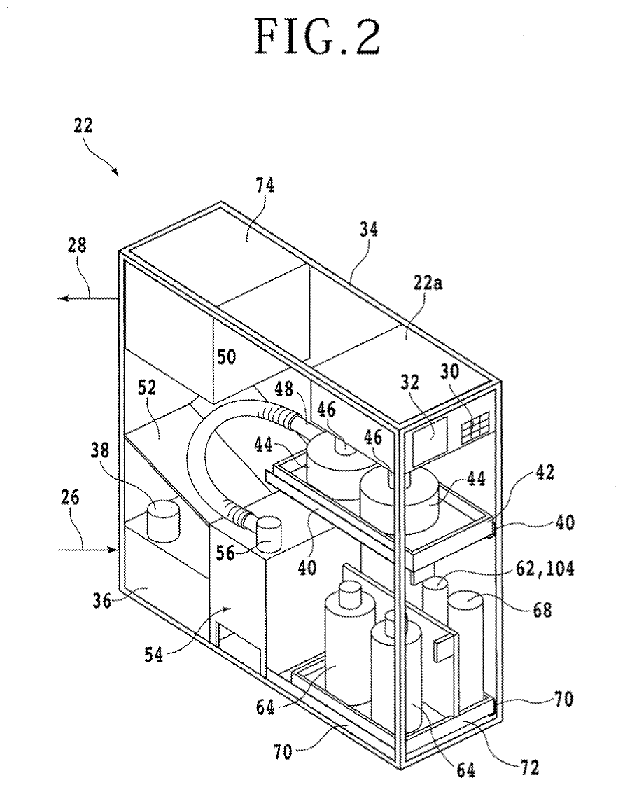

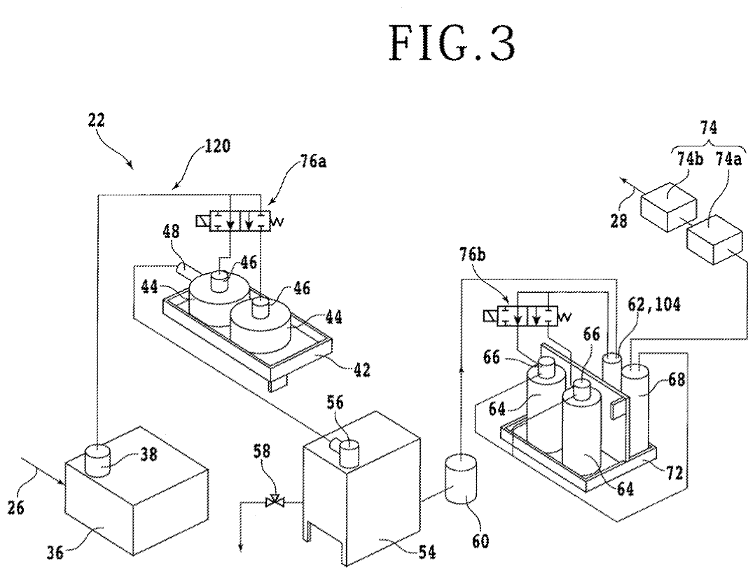

FIG. 2 is a perspective view schematically depicting the individual elements inside the housing 24 of the pure water production system 22 according to this embodiment. In FIG. 2, a water path through which water flows is omitted in parts for the convenience of description. FIG. 3 is an exploded perspective view schematically illustrating a connection layout of the individual elements accommodated inside the housing 24 of the pure water production system 22 according to this embodiment. In FIG. 3, portions of a water path 120 are indicated simply as lines for the convenience of description. The water path 120 is formed, for example, of metal- or resin-made pipes or tubes, or the like.

The pure water production system 22 includes a frame 34 that supports the individual elements. On a bottom wall of the frame 34, a waste fluid storage tank 36 is disposed to store water (waste fluid) drained from the processing apparatus 2. The water drained from the processing apparatus 2 is transferred through the water drainage path 26, is supplied to the waste fluid storage tank 36, and is stored in the waste fluid storage tank 36. Described specifically, water, which contains contaminant particles such as processing debris and impurity ions, is supplied as a processing waste fluid from the processing apparatus 2 to the waste fluid storage tank 36. To the waste fluid storage tank 36, a waste fluid supply pump 38 is connected to deliver water stored in the waste fluid storage tank 36. The waste fluid supply pump 38 supplies the water, which is stored in the waste fluid storage tank 36, to first filter units 44 to be described subsequently herein. By this waste fluid supply pump 38, the amount of the water to be supplied from the waste fluid storage tank 36 to the first filter units 44 is controlled.

Above the waste fluid storage tank 36, a pair of guide rails 40 is disposed. The paired guide rails 40 are fixed on the frame 34, extending along a length direction of the pure water production system 22 with a predetermined distance left therebetween in a width direction of the pure water production system 22. On the paired guide rails 40, a pan 42 of a rectangular shape as seen in plan is mounted slidably along the guide rails 40. This configuration enables pulling of the pan 42 out of the frame 34 and placing of the pan 42 in the frame 34. On the pan 42, the first filter units 44 are detachably mounted to filter water (waste fluid) supplied from the waste fluid storage tank 36. To inflow portions 46 on upper ends of the first filter units 44, the waste fluid supply pump 38 is connected via the water path 120 in which a selector valve 76a is disposed. The water stored in the waste fluid storage tank 36 is supplied to the respective first filter units 44 by the waste fluid supply pump 38. It is to be noted that no limitation is imposed on the number of the first filter units 44 although FIG. 2 and some other figures present an example in which two first filter units 44 are disposed on the pan 42.

The first filter units 44 each contain a filter element (not presented) formed, for example, of activated carbon, zeolite, fabric, resin-made fibers, glass fibers, a metal mesh, a reverse osmosis (RO) membrane, or the like. The first filter units 44 adsorb impurities, which are contained in the water flowed in from the inflow portions 46, such as processing debris on the filter elements or filter them out, and therefore purify the water. The water (clear water) filtered by the first filter units 44 accumulates in the pan 42, is discharged from a water discharge path 48, and flows to a downstream side of the water path 120.

In a region on a side lower than the first filter units 44 and the pan 42 and adjacent the waste fluid storage tank 36, a clear water storage tank (filtered water storage tank) 54 is disposed to store the water (clear water) filtered by the first filter units 44. The clear water storage tank 54 includes an inflow portion 56 disposed on the side of an upper wall of the clear water storage tank 54. The filtered water (clear water) flows into the clear water storage tank 36 through the inflow portion 56. Therefore, the first filter units 44 are each connected to the clear water storage tank 54 via the pan 42. Described specifically, the water discharge path 48 of the pan 42 and the inflow portion 56 of the clear water storage tank 54 are connected by a flexible hose 50 that makes up a portion of the water path 120. The hose 50 is supported, for example, by a tilted support board 52. The water (clear water) filtered in and discharged from the first filter units 44 is temporarily held in the pan 42 and is then supplied to the clear water storage tank 54 via the hose 50 and stored in the clear water storage tank 54.

At a position adjacent the clear water storage tank 54 in the pure water production system 22, a pair of guide rails 70 is disposed. The guide rails 70 are fixed on the frame 34 in a similar fashion as the guide rails 40 except for a difference in their installation positions. On the paired guide rails 70, a pan 72 of a rectangular shape as seen in plan is mounted slidably along the guide rails 70. This configuration enables pulling of the pan 72 out of the frame 34 and placing of the pan 72 in the frame 34.

As illustrated in FIG. 3, the clear water storage tank 54 may be provided with a drainage system 58 including an on/off valve. The drainage system 58 has a function to drain the water (clear water), which is stored in the clear water storage tank 54, out of the pure water production system 22, and to dispose of the same. The water has been filtered by the first filter units 44 and can hence be disposed of as it is if it meets conditions for disposal at a device chip fabrication plant or the like where the processing apparatus 2 is installed. Water may be lost, for example, through splashing out of the processing apparatus 2 while it is circulating between the pure water production system 22 and the processing apparatus 2. Therefore, fresh pure water may be supplied from an outside to the pure water production system 22 and the processing apparatus 2. If any excess amount of water is stored in the pure water production system 22, on the other hand, the drainage system 58 may be used for disposing it to an outside.

The clear water storage tank 54 includes an outflow portion (not illustrated) in a lower part thereof. To a downstream side of the clear water storage tank 54, a clear water supply pump 60 (see FIG. 3) is connected via the water path 120. To a downstream side of the clear water supply pump 60, an ultraviolet light irradiation unit 62 is connected via the water path 120. The ultraviolet light irradiation unit 62 includes an ultraviolet light source such as an ultraviolet fluorescent lamp, and irradiates ultraviolet light to the water (clear water) supplied from the clear water storage tank 54. The ultraviolet light irradiation unit 62 is disposed on the pan 72. In the water used in the processing apparatus 2, microorganisms, for example, suspended in the air have mixed as impurities. In the ultraviolet light irradiation unit 62, ultraviolet light is thus irradiated to the water (clear water) for sterilization treatment. In addition, the irradiation of ultraviolet light to the water can also break down other organic matter and the like contained in the water. It is to be noted that, regarding the ultraviolet light irradiation unit 62, details will be described later.

To a downstream side of the ultraviolet light irradiation unit 62 in the water path 120, ion exchange resin units 64 are connected. FIGS. 2 and 3 schematically present a case in which two ion exchange resin units 64 are detachably disposed on the pan 72, although the number of the ion exchange resin units 64 is not limited to two. The ion exchange resin units 64 each contain ion exchange resins to replace ions contained in the water to which ultraviolet light has been irradiated in the ultraviolet light irradiation unit 62.

Inflow/outflow portions 66 on upper ends of the ion exchange resin units 64 are connected to the ultraviolet light irradiation unit 62 via the water path 120 in which a selector valve 76b is disposed. The ion exchange resin units 64 each have, for example, a cylindrical vessel and the ion exchange resins packed in the vessel. Inside each vessel, a flow path is formed by interstices of the ion exchange resins so that the water entered the ion exchange resin unit 64 passes through the interstices of the ion exchange resins and reaches the inflow/outflow portion 66. In each vessel, an ion exchange resin (cation exchange resin), which replaces cations, and another ion exchange resin (anion exchange resin), which replaces anions, are contained in a mutually-mixed state, for example. Cations and anions other than hydrogen ions and hydroxide ions among the ions contained in the water supplied to the ion exchange resin units 64 are hence replaced to hydrogen ions and hydroxide ions, respectively. Pure water is therefore produced by the ion exchange resin units 64.

The inflow/outflow portions 66 of the ion exchange resin units 64 are connected to the water path 120 so that the water (pure water) subjected to ion exchange by the ion exchange resins is delivered to a second filter unit 68 via the water path 120. The second filter unit 68 is detachably disposed on the pan 72, and has a function to finally filter the water subjected to the ion exchange through the ion exchange resin units 64.

The second filter unit 68, similar to the first filter units 44, contains a filter element (not presented) formed, for example, of activated carbon, zeolite, fabric, resin-made fibers, glass fibers, a metal mesh, a reverse osmosis (RO) membrane, or the like. The water drained as a processing waste fluid from the processing apparatus 2 is progressively purified in the course of its flow along the water path 120 of the pure water production system 22, and has been purified to a final stage at the stage that it has reached the second filter unit 68. As turbidity (impurities) contained in the water is extremely low at a trace level, the filter element is required to have performance suited for the elimination of such turbidity. As the filter element of the second filter unit 68, a membrane that is finer in mesh than the filter elements of the first filter units 44 and is of a level called “microfilter” may be preferably used, for example. The second filter unit 68 purifies the water by adsorbing or filtering off with the filter element, the extremely trace level of turbidity contained in the water flowed thereinto. The water (pure water) filtered by the second filter unit 68 flows along the water path 120 to a downstream side, and reaches a pure water supply unit 74 fixed on an upper part of the frame 34.

The pure water supply unit 74 has a function to supply the pure water, which has been filtered and produced through the second filter unit 68, to the processing apparatus 2 via the water supply path 28. The pure water supply unit 74 includes a pure water storage tank 74a that stores the produced pure water, and a temperature controller 74b that adjusts the temperature of the pure water to be supplied from the pure water storage tank 74a to the processing apparatus 2. The temperature controller 74b includes, for example, a temperature adjustment system (not illustrated) having a heating device such as an electrically heated wire and a cooling device such as a Peltier device, and has a function to adjust the temperature of the pure water to be supplied to the processing apparatus 2.

The water to be supplied from the pure water supply unit 74 to the processing apparatus 2 has been removed of contaminant particles and ions, and is used as pure water in the processing apparatus 2. As described above, the waste fluid drained from the processing apparatus 2 is purified by the pure water production system 22, is returned to the processing apparatus 2, and is used as pure water in the processing apparatus 2. The water path 120 serves as a flow path for the water that is delivered from the processing apparatus 2, flows through the waste fluid storage tank 36, first filter units 44, clear water storage tank 54, ultraviolet light irradiation unit 62, ion exchange resin units 64, second filter unit 68, and pure water supply unit 74, and is returned to the processing apparatus 2.

On another upper part of the frame 34, a control unit 22a is disposed. The control unit 22a is connected to the individual elements of the pure water production system 22. For example, the control unit 22a includes a computer having a processor and a storage section with programs stored therein, and based on functions of the programs, controls operations of the individual elements of the pure water production system 22. The control unit 22a includes the input unit 30 that is used to input predetermined information to the pure water production system 22, and the display unit 32 that displays predetermined information regarding the pure water production system 22. For example, the input unit 30 includes a plurality of operation keys, and the display unit 32 includes a display. It is to be noted that the control unit 22a may include a touch panel that functions as the input unit 30 and the display unit 32. For example, production conditions for water (the amount, temperature, and the like of pure water to be produced) and the like are inputted in the control unit 22a via the input unit 30. On the display unit 32, on the other hand, the operation status of the pure water production system 22, the production conditions for water, and the like are displayed.

Conventionally, an ultraviolet light irradiation unit includes a tank that stores water, and an ultraviolet light source that is disposed inside the tank to irradiate ultraviolet light to the water stored in the tank. For example, the ultraviolet light source is submerged in the water stored in the tank. In the tank, however, the ultraviolet light cannot act at a sufficient intensity on the water remote from the ultraviolet source, and therefore organic matter such as microorganisms may remain in the water. The organic matter which has not been broken down is not eliminated by an ion exchange resin unit 64 so that impurities may remain in the produced pure water. The pure water production system 22 according to this embodiment, specifically the ultraviolet light irradiation unit 62 is therefore configured as will be described below such that ultraviolet light is sufficiently irradiated to water and organic matter contained in the water can be broken down appropriately. A detailed description will hereinafter be made about the ultraviolet light irradiation unit 62.

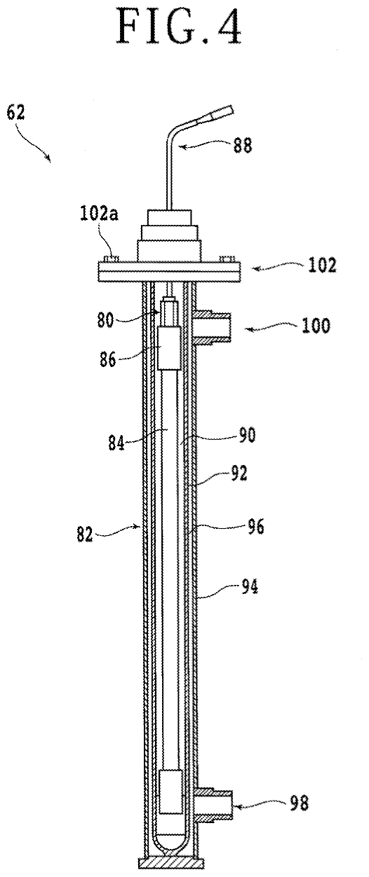

FIG. 4 is a cross-sectional view schematically depicting the ultraviolet light irradiation unit 62 disposed in the pure water production system 22 according to this embodiment. The ultraviolet light irradiation unit 62 has an ultraviolet fluorescent lamp 80 that acts as an ultraviolet light source, and an outer tube 82 that is configured to allow the water to flow through surroundings of the ultraviolet fluorescent lamp 80. The ultraviolet fluorescent lamp 80 includes a fluorescent tube 84 with a phosphor coated on an inner wall thereof, an electrode terminal portion 86 disposed on an end portion of the fluorescent tube 84, and a power cable 88 as a supply route of electric power to the electrode terminal portion 86. The electrode terminal portion 86 includes filaments exposed to an interior of the fluorescent tube 84. When electric power is supplied to the electrode terminal portion 86 via the power cable 88, an electrical discharge takes place inside the fluorescent tube 84 such that ultraviolet light is emitted from the phosphor. As schematically depicted in FIG. 4, the outer tube 82 is a cylindrical tube arranged so as to accommodate the ultraviolet fluorescent lamp 80 therein, and internally defines, along a vertical direction, a cylindrical accommodation space 90 that can accommodate the ultraviolet fluorescent lamp 80. The outer tube 82 includes an inner wall 92 facing the accommodation space 90, and an outer wall 94 facing an outer space on a side outer than the inner wall 92, and the space between the inner wall 92 and the outer wall 94 serves as a flow path 96 along which the water flows. For the inner wall 92 and the outer wall 94, silica glass may be used preferably. If silica glass is used, no metal ions mix in the water that flows along the flow path 96.

The distance between the inner wall 92 and the outer wall 94, which form the flow path 96, may be set preferably at 4 mm or greater and 5 mm or smaller. However, the distance is not limited to such a range. As the distance between the inner side (inner wall 92) of the outer tube 82 as the cylindrical tube and the outer side of the ultraviolet fluorescent lamp 80, the smaller the more preferred. For example, the distance may preferably be set at 7.5 mm or smaller, with 3 mm or greater and 5 mm or smaller being more preferred. However, the distance is not limited to such a range.

The outer tube 82 includes an inflow port 98 through which water flows in, and an outflow port 100 through which the water irradiated with ultraviolet light from the ultraviolet fluorescent lamp 80 flows out. For example, the water inflow port 98 is disposed in the outer wall 94 in a vicinity of a lower end thereof, while the water outflow port 100 is disposed in the outer wall 94 in a vicinity of an upper end thereof. The water inflow port 98 is connected to the clear water supply pump 60 on an upstream side of the water path 120. The water (clear water) stored in the clear water storage tank 54 is delivered by the clear water supply pump 60 into the inflow port 98 of the ultraviolet light irradiation unit 62. Then, the water is supplied to a lower portion of the flow path 96 and flows upward along the flow path 96. The outflow port 100, on the other hand, is connected to the ion exchange resin units 64 on a downstream side of the water path 120. The water which has reached near an upper end of the flow path 96 flows out of the ultraviolet light irradiation unit 62 from the outflow port 100, and is delivered to the ion exchange resin units 64.

On an upper end of the outer tube 82, a lid 102 is fixedly fastened by fixing members 102a such as bolts such that the accommodation space 90 and the flow path 96 are closed. Through a central portion of the lid 102, a through-hole is formed extending in an up-and-down direction, and the power cable 88 for the ultraviolet fluorescent lamp 80 extends in the through-hole. For example, the power cable 88 is fixed on the lid 102, and inside the accommodation space 90, the ultraviolet fluorescent lamp 80 is suspended via the power cable 88 and is arranged at a predetermined height.

In the ultraviolet light irradiation unit 62, water (clear water) flows from down toward above along the flow path 96 in the outer tube 82. If the ultraviolet fluorescent lamp 80 is kept on, ultraviolet light is irradiated from the ultraviolet fluorescent lamp 80 to the moving water. Here, the ultraviolet light to be irradiated to the water from the ultraviolet fluorescent lamp 80 may preferably contain the 254-nm wavelength component and the 185-nm wavelength component. Further, the output of the ultraviolet fluorescent lamp 80 may be set at approximately 65 W to 150 W. Furthermore, the flow rate of the water flowing through the outer tube 82 may be set, for example, at approximately 2.3 L/min. However, the flow rate of the water is not limited to such a value.

In the water used in the processing apparatus 2, microorganisms, for example, suspended in the air are mixed as impurities. The ultraviolet fluorescent lamp 80 can however sterilize the water, which is flowing through the outer tube 82, by ultraviolet light of 254-nm wavelength. If the microorganisms become extinct, their carcasses remain in the water. In addition, other organic matter is also mixed in the water. The ultraviolet fluorescent lamp 80 can degrade the organic matter, which is contained in the water, into ions by 185-nm ultraviolet light. This 185-nm ultraviolet light activates ozone contained in the water and promotes the degradation of the organic matter with ozone. In the ultraviolet light irradiation unit 62, there is a limitation by the flow path 96 to a region over which the water flows so that the water does not flow at a large distance from the ultraviolet fluorescent lamp 80. Accordingly, ultraviolet light can be sufficiently irradiated to the flowing water in the ultraviolet light irradiation unit 62, and the microorganisms and other organic matter contained in the water can be fully broken down.

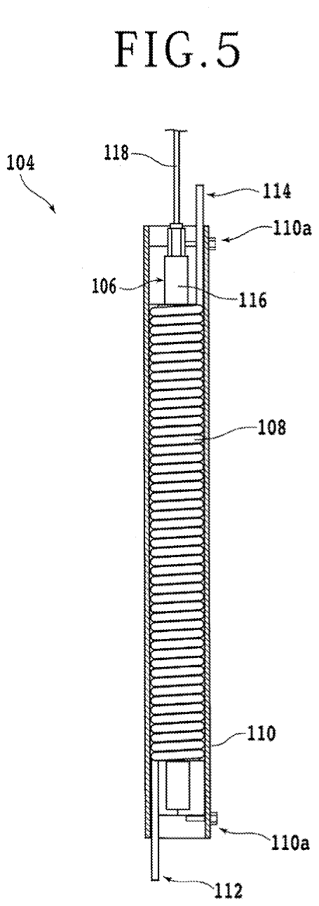

A description will next be made about a modification of the ultraviolet light irradiation unit 62 disposed in the pure water production system 22 according to this embodiment. FIG. 5 is a side view schematically depicting an ultraviolet light irradiation unit 104 according to this modification. Similar to the ultraviolet light irradiation unit 62 described with reference to FIG. 4, the ultraviolet light irradiation unit 104 has an ultraviolet fluorescent lamp 106 as an ultraviolet light source, and an outer tube 108 configured to allow water to flow through surroundings of the ultraviolet fluorescent lamp 106. However, the ultraviolet light irradiation unit 104 is different primarily in the shape of the outer tube 108 from the ultraviolet light irradiation unit 62. As depicted in FIG. 5, the outer tube 108 included in the ultraviolet light irradiation unit 104 is a helical tube of a shape that is wound in a helical pattern around the ultraviolet fluorescent lamp 106. The ultraviolet fluorescent lamp 106 is configured similar to the ultraviolet fluorescent lamp 80 depicted in FIG. 4, and has a fluorescent tube (not depicted) surrounded by the outer tube 108, an electrode terminal portion 116 disposed on an end portion of the fluorescent tube, and a power cable 118 connected to the electrode terminal portion 116.

As the distance between the inner side of the helical tube as the outer tube 108 and the outer side of the fluorescent tube of the ultraviolet fluorescent lamp 106, the smaller the more preferred. For example, the distance may preferably be set at 7.5 mm or smaller, with 3 mm or greater and 5 mm or smaller being more preferred. However, the distance is not limited to such a range. Further, the inner diameter of the helical tube may be set, for example, at approximately 4 to 6 mm, and its outer diameter may be set, for example, at approximately 6 to 8 mm. However, the inner diameter and the outer diameter are not limited to such ranges, and may be set as needed in a range that the outer diameter is greater than the inner diameter. The outer tube 108 and the ultraviolet fluorescent lamp 106 are accommodated in a pipe 110, and are fixed by fixing members 110a or the like. A water inflow port 112 is disposed on a lower end of the outer tube 108, and a water outflow port 114 is disposed on an upper end of the outer tube 108. The outer tube 108 is wound approximately 50 to 60 turns between the inflow port 112 and the outflow port 114. However, the outer tube 108 is not limited to such a shape.

The water (clear water) supplied by the clear water supply pump 60 to the inflow port 112 of the outer tube 108 flows upward while swirling in the interior of the outer tube 108 as the helical tube, and is delivered from the outflow port 114 toward the ion exchange resin units 64. If the ultraviolet fluorescent lamp 106 is kept on at this time, ultraviolet light can be irradiated to the water. The flow route of the water is restricted to the surroundings of the ultraviolet fluorescent lamp 106 owing to the shape of the outer tube 108, and therefore the water is ensured to pass through a range where ultraviolet light can be effectively irradiated. The microorganisms and organic matter contained in the water can therefore be broken down surely. Especially, if the outer tube 108 is the helical tube, the flow path of the water exposed to florescent light from the ultraviolet fluorescent lamp 106 can be extremely increased in length and transverse plane, and therefore ultraviolet light can be efficiently irradiated to the water.

As described above, in the pure water production system 22 according to this embodiment, specifically the ultraviolet light irradiation unit 62 or 104, water is allowed to flow through the outer tube 82 or 108 disposed surrounding the ultraviolet fluorescent lamp 80 or 106 such that the microorganisms and other organic matter contained in the water can be broken down certainly. Consequently, the range in which the water flows is restricted, and the water is allowed to flow in a range that ultraviolet light can sufficiently act. For example, the greater the output of the ultraviolet fluorescent lamp 80 or 106, the more the water can be sterilized, and the more distance the ultraviolet light can be irradiated at an effective intensity. Therefore, the outer tube 82 or 108 can be enlarged in size, and the water can be increased in flow rate (L/min). Various dimensions of the outer tube 82 or 108 and the flow rate (L/min) of water through the outer tube 82 or 108 can be changed as needed to an extent that organic matter and the like can be broken down by the ultraviolet fluorescent lamp 80 or 106, and are not limited to the above-mentioned values.

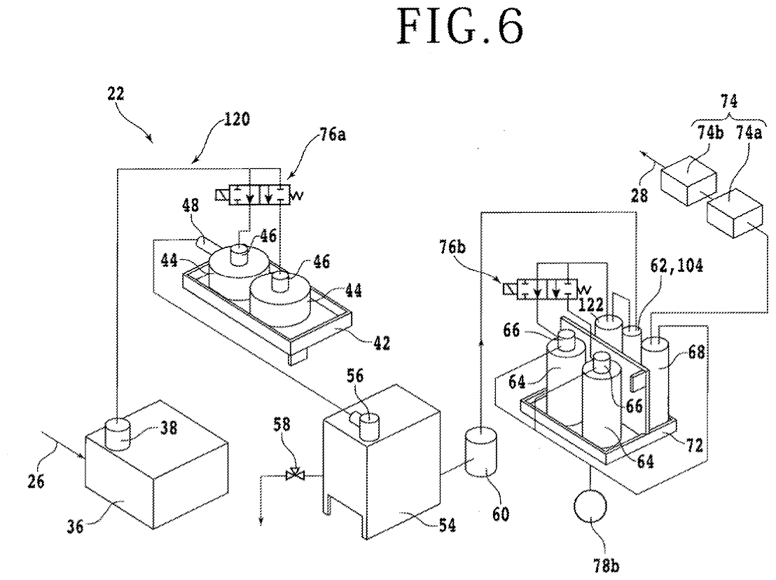

It is to be noted that, in the embodiment described above, the description is made about the case in which the two sets of filter units, one being the filter units 44 and the other the filter unit 68, are included in the pure water production system 22, and the water that is flowing along the water path 120 is filtered in the filter units 44 and the filter unit 68, respectively. However, the pure water production system 22 according to the aspect of the present invention is not limited to such a configuration. As a first modification of the above-described embodiment, the pure water production system 22 may include a still further filter unit. FIG. 6 is an exploded perspective view schematically illustrating the configuration of a pure water production system 22 according to the first modification, which includes a third filter unit 122. In the pure water production system 22 according to the first modification as illustrated in FIG. 6, the third filter unit 122 is disposed in the water path 120 between the ultraviolet light irradiation unit 62 or 104 and the ion exchange resin units 64. The third filter unit 122 has, for example, a function to eliminate organic matter and the like derived from the carcasses of microorganisms as produced by the irradiation of ultraviolet light to the water in the ultraviolet light irradiation unit 62 or 104. In this case, the third filter unit 122 is packed with a third filter element of a type that is suited for the elimination of a predetermined object of elimination such as organic matter from water.

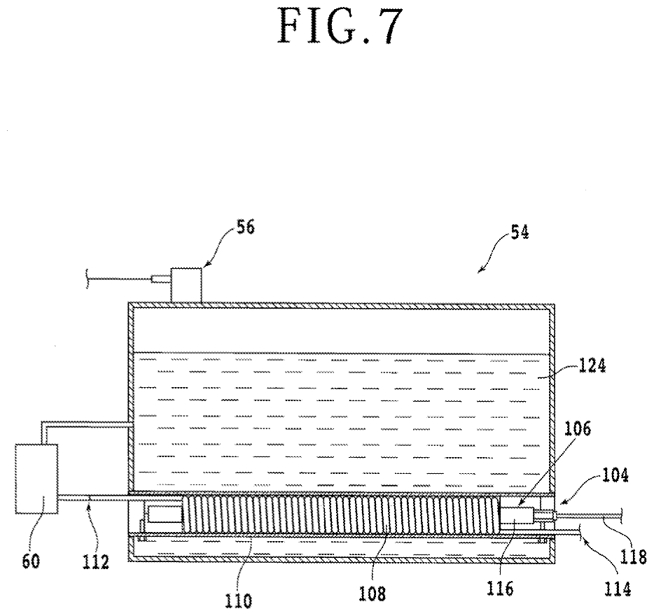

In the embodiment and its first modification, both described above, the description is made about the case in which the ultraviolet light irradiation unit 62 or 104 is arranged downstream of the clear water storage tank 54 in the water path 120. However, the first aspect of the present invention is not limited to such an arrangement. As a second modification of the above-described embodiment, the ultraviolet light irradiation unit 62 or 104 may be incorporated in the clear water storage tank 54 such that the ultraviolet light irradiation unit 62 or 104 is submerged in the water (clear water) stored in the clear water storage tank 54. FIG. 7 is a cross-sectional view schematically depicting the clear water storage tank 54, in which the ultraviolet light irradiation unit 104 of FIG. 5 is incorporated, in the second modification. The clear water storage tank 54 depicted in FIG. 7 receives water (clear water) 124, which has been filtered in the first filter units 44, through the inflow portion 56, and stores the water 124 therein. Here, the ultraviolet light irradiation unit 104 is submerged in the water 124. The water 124 stored in the clear water storage tank 54 is delivered by the clear water supply pump 60 to the ultraviolet light irradiation unit 104, and the ultraviolet light irradiation unit 104 irradiates ultraviolet light to the water 124 and breaks down organic matter and the like contained in the water 124.

At this time, a portion of the ultraviolet light radiates and leaks outward through the outer tube 108 of the ultraviolet light irradiation unit 104, and travels to the water 124 stored in the clear water storage tank 54. Compared with the water 124 flowing inside the outer tube 108, the water 124 stored in the clear water storage tank 54 is more distant from the fluorescent tube of the ultraviolet fluorescent lamp 106 in the ultraviolet light irradiation unit 104, and is exposed to ultraviolet light at a lower intensity. Nonetheless, the effect of breakdown of organic matter by ultraviolet light is produced not a little so that the organic matter which is contained in the water 124 stored in the clear water storage tank 54 can be provisionally broken down by a leak of ultraviolet light. For such provisional breakdown of organic matter, no additional ultraviolet light source is needed for the clear water storage tank 54, and the ultraviolet light emitted from the ultraviolet fluorescent lamp 106 can be fully used. The incorporation of the ultraviolet light irradiation unit 104 in the clear water storage tank 54 can therefore break down organic matter and the like contained in the water 124 more efficiently and certainly.

The present invention is not limited to the details of the above-described preferred embodiment. The scope of the invention is defined by the appended claims and all changes and modifications as fall within the equivalence of the scope of the claims are therefore to be embraced by the invention.

What is claimed is:

1. A pure water production system comprising:
a waste fluid storage tank that stores water drained from a processing apparatus;
a filter unit that filters water delivered from the waste fluid storage tank;
a clear water storage tank that stores water filtered by the filtration unit;
an ultraviolet light irradiation unit that irradiates ultraviolet light to water delivered from the clear water storage tank and breaks down organic matter contained in the water;
an ion exchange resin unit that replaces ions contained in water delivered from the ultraviolet light irradiation unit, thereby producing pure water from the water; and
a pure water supply unit that supplies the pure water produced by the ion exchange resin unit to the processing apparatus,
wherein the ultraviolet light irradiation unit includes an ultraviolet fluorescent lamp, and an outer tube configured to allow the water to flow through surroundings of the ultraviolet fluorescent lamp, and
the outer tube includes an inflow port through which the water flows in, and an outflow port through which the water irradiated with ultraviolet light from the ultraviolet fluorescent lamp flows out.

2. The pure water production system according to claim 1, wherein the outer tube included in the ultraviolet light irradiation unit is a helical tube of a shape that is wound in a helical pattern around the ultraviolet fluorescent lamp.

3. The pure water production system according to claim 2, wherein a distance between an inner side of the helical tube and an outer side of the ultraviolet fluorescent lamp is 7.5 mm or smaller.

4. The pure water production system according to claim 1, wherein the outer tube included in the ultraviolet light irradiation unit is a cylindrical tube disposed such that the ultraviolet fluorescent lamp is accommodated therein.

5. The pure water production system according to claim 4, wherein a distance between an inner side of the cylindrical tube and an outer side of the ultraviolet fluorescent lamp is 7.5 mm or smaller.

6. The pure water production system according to claim 1,
wherein the ultraviolet light from the ultraviolet fluorescent lamp contains a 254-nm wavelength component and a 185-nm wavelength component,
the ultraviolet fluorescent lamp sterilizes the water flowing through the outer tube by the 254-nm wavelength component of the ultraviolet light, and degrades organic matter contained in the water flowing through the outer tube into ions by the 185-nm wavelength component of the ultraviolet light, and
the ultraviolet light irradiation unit is incorporated in the clear water storage tank, and provisionally breaks down organic matter contained in the water stored in the clear water storage tank by a leak of the ultraviolet light through the outer tube.

7. An ultraviolet light irradiation unit comprising:
an ultraviolet fluorescent lamp; and
a helical tube of a shape that is wound in a helical pattern around the ultraviolet fluorescent lamp,
wherein the helical tube includes an inflow port through which water flows in, and an outflow port through which the water irradiated with ultraviolet light from the ultraviolet fluorescent lamp flows out.
